(19) United States
(12) Patent Application Publication
(10) Pub. No.: US 2007/0132547 A1
(43) Pub. Date: Jun. 14, 2007

(54) System for sending information of container and system for tracing container comprising the same

(75) Inventor: Woosun Jung, Seoul (KR)

Correspondence Address: GLOBAL IP COUNSELORS, LLP, 1233 20TH STREET, NW, SUITE 700, WASHINGTON, DC, 20036-2680, US

(73) Assignee: 2-Track Limited, London (GB)

(21) Appl. No.: 10/579,234

(22) PCT Filed: Nov. 12, 2004
(86) PCT No.: PCT/KR04/02941

§ 371 Date: May 12, 2006

(30) Foreign Application Priority Data
Nov. 14, 2003 (KR) 10-2003-0080441

(51) Int. Cl. G05B 19/00

(52) U.S. Cl. 340/5.6

(57) ABSTRACT

It is necessary to minimize the costs needed to establish a physical distribution tracking system in order to maximally reduce the physical distribution costs leading to the increase in product costs when establishing the physical distribution tracking system for confirming container information in real time including information on a position and sealing state of a container. According to the present invention for achieving the aforementioned object, a system for sending container information including information on a position and sealing state of a container comprises (1) an electronic seal device which is provided to the container and includes a radio frequency communication module, (2) a container information transceiver which is disposed to the container, includes a radio frequency communication module, and receives the information on the sealing state of the container from the electronic seal device through the radio frequency communication module, (3) a relay which is arranged in a container yard where containers are collected or on a transportation means that carries the containers, and includes a radio frequency communication module capable of communicating with the container information transceiver and a satellite communication module capable of performing a satellite communication, and (4) a positional information acquisition means which is mounted to at least one of the container information transceiver and the relay and can acquire the positional information of the container.

### FIELD OF THE INVENTION

The present invention relates to a system for transmitting container information and a system for tracing a container comprising the same.

### TECHNICAL BACKGROUND

Conventional CVO (Commercial Vehicle Operation) has provided services for acquiring information on freight and vehicles during transport and for providing consignors and carriers with information on freight contents and arrival time. However, a manual system in which a driver should report the state of transport via a mobile phone during transport to provide the above services has a problem in that its reliability is low and in that the freight can be located only when it is loaded or unloaded. Further, to prevent theft or robbery during the transport of containers and behavior that a third party unseals the sealed containers in transit or storage and transports explosives via the unsealed containers, it is necessary to monitor positional information on the containers in real time over the entire process of loading, unloading and transporting the freight and to check whether the seal of the container is broken.

With respect to such a physical distribution system for checking the sealing state of the container, Korean Patent Laid-Open Publication No. 2003-0058978 discloses a system for tracing a physical distribution and preventing smuggling using an electronic seal, GPS and a short range wireless communication. According to the aforementioned system, however, the location and sealing state of the containers can be checked only at base stations established on only the origin, transition and destination places. Therefore, there is a problem in that the location and information of the freight cannot be confirmed in real time and the seal breakage occurred after the sealing state of the container has been checked during the transport or at the base station cannot also be checked.

Furthermore, the costs for establishing a physical distribution tracking system should be minimized in order to maximally reduce the physical distribution costs leading to the increase in product costs when establishing the physical distribution tracking system for real-time confirmation of container information including the positional information of the containers, the condition information of the containers regarding the temperature, the humidity and whether radioactive or biochemical materials have been leaked out, and the information on the sealing state of the containers.

### DETAILED DESCRIPTION OF THE INVENTION

The present invention is conceived to solve the aforementioned problems of the prior art. Accordingly, an object of the present invention is to provide a system for transmitting information on a container and a system for tracking a container using the information transmitting system, wherein costs for establishing a physical distribution tracking system can be reduced when intending to establish the system for sending in real time the container information including information on a position and the sealing state of the electronic sealing device for the container and the system for tracking the container using the container information sending system.

A first embodiment of a system for sending container information including information on a position and sealing state of a container according to the present invention for achieving the object comprises (1) an electronic seal device which is provided in the container and includes a radio frequency communication module, and (2) a relay which is disposed in a container yard where containers are collected or on a transportation means that carries the containers. The relay comprises a radio frequency communication module capable of communicating with the electronic seal device, a positional information acquisition means capable of acquiring positional information of the container, and a satellite communication-module capable of performing a satellite communication.

The terms used in the specification and/or the appended claims will be defined.

A term “container” as used herein should be construed in the widest way as including a freight transport/packaging container that is made of steel to package and transport the freight. A term “electronic seal device” as used herein is a seal device for use in sealing a container to determine whether a state where the freight has been loaded into the container remains unchanged until a final destination of the transported containers. The seal device is used as a device that can determine the sealing state of the container is remained by a sensing means for sensing the sealing state of the container, which includes an electronic circuit capable of sensing whether the sealing state is maintained. A term “container information” as used herein should be construed in the widest sense as including the positional information of a container and the condition information of a container such as the sealing state, inside temperature and humidity of the container and whether radioactive and biochemical materials have been leaked out from the container. Furthermore, a term “radio frequency communication module” as used herein includes a wireless communication module using a radio frequency (RF) and should be construed in the widest sense as including an antenna for the wireless communication. A term “positional information acquisition means” as used herein should be construed as including a means for acquiring the positional information of the container including a GPS (Global Positioning System) terminal for receiving GPS information from GPS satellites.

Furthermore, a process of transporting a container will be described. A container is transferred from an origin place such as a factory, where freight is loaded into the container, to a final destination place via a ground transportation means such as a container truck or train, an intermediate transition place such as a harbor, a truck terminal or a container yard, and ocean or air transportation means such as ship or aircraft. In general, the ground transportation means such as a container truck transports one or two containers loaded thereon, due to the volume or weight of the container, whereas more containers can be disposed at the intermediate transition place, on the ocean or air transportation means, or on the train. The relay of the present invention is placed either at the transportation means while the container is transported or at the container yard where the containers are collected, such that it can transmit the container information all the way through the path of the container. Further, the relay may be mounted to the chassis of a vehicle if the transportation means is a vehicle such a truck; to the deck or the top of a cabin if the transportation means is a ship; or to the leading end of the cargo bay if the transportation means is an airplane. Preferably, the relay is mounted in a position where radio frequency communication, satellite communication and receipt of GPS information from GPS satellites can be conducted with ease.

In the meantime, the present invention is conceived to consider the aforementioned path of the container. That is, the system for sending the container information according to the present invention is configured in such a manner that an electronic seal device having a relatively inexpensive radio frequency communication module is installed on the respective containers, and a relatively expensive relay is installed on a transportation means such as a truck, which carries the container, such that the container information can be sent through the satellite communication module thereof. Further, the relay that includes the radio frequency communication module and the satellite communication module to be able to communicate with a plurality of electronic seal devices is installed either at an intermediate transition place where the plurality of containers are collected or to the ocean/air transportation means or train that carries the plurality of containers, such that the relay performs the radio frequency communication with the electronic seal device and sends the acquired information on the sealing state to a third party through the satellite communication module. Thus, it will be understood that the relay is not installed on the container.

With such a constitution, the system for sending the container information according to the present invention can greatly reduce costs for establishing a system for sending information on a plurality of containers in real time through a satellite. Thus, according to the present invention, total costs for establishing a system for sending the container information including information on a position and sealing state of a container that is carried by a variety of transportation means or places as described in the above can be greatly reduced.

The operation of the system for sending the container information according to the present invention will be described in more detail. Information for confirming the sealing state of the container, which is generated from the electronic seal device, is transmitted to the relay, and the relay sends the sealing state of the container by means of the satellite communication module of the relay. Therefore, the costs for establishing the system for sending the container information can be reduced. Further, since the container information including the positional information of the container obtained by a means for a container position information acquiring means mounted to the relay is sent by the satellite communication module, the costs for establishing the system for sending the container information capable of confirming the position and sealing state of the container in real time can be reduced.

A second embodiment of a system for sending container information including information on a position and sealing state of a container according to the present invention comprises (1) an electronic seal device which is provided in the container and includes a radio frequency communication module; (2) a container information transceiver which is disposed in the container and includes a radio frequency communication module and a condition information acquisition module for acquiring condition information of the container; (3) a relay which is disposed in a container yard where containers are collected or on a transportation means that carries the containers, and includes a radio frequency communication module capable of communicating with the electronic seal device and the container information transceiver, and a satellite communication module capable of performing a satellite communication; and (4) a positional information acquisition means capable of acquiring positional information of the container.

The condition information acquisition module is a module for acquiring condition information such as the information of the temperature and humidity in the container, whether radioactive materials have been leaked out, and whether biochemical materials have been leaked out. The condition information acquisition module may be integrally formed with a variety of sensors for sensing the condition information, e.g. an electronic thermometer, an electronic hygrometer, a radioactive material detector and biochemical material detector. Otherwise, when the sensors are manufactured separately from the condition information acquisition module since the sensors should be arranged discretely at optimum positions in the container to acquire the condition information, the condition information acquisition module may include an interface unit which is connected to the sensors to receive signals generated by the sensors. The detailed description thereof will be omitted herein since this configuration has been already described in a variety of conventional examples.

According to the second embodiment of the present invention, it is configured in such a manner that the aforementioned system for sending the container information further comprises the container information transceiver mounted to the container; the relay performs a radio frequency communication even with the container information transceiver; and the positional information acquisition means is included in the container information transceiver or relay. The container information transceiver includes the condition information acquisition module for acquiring the condition information of the container and is configured to transmit the information acquired by the condition information acquisition module, such as the information on the temperature and humidity in the container, whether the container has been damaged, whether radioactive materials have been leaked out, and whether biochemical materials have been leaked out, to the relay via a radio frequency communication. Further, the positional information of the container is transmitted to the relay and then is sent to the satellite when it is acquired from the positional information acquisition means mounted to the container information transceiver.

A third embodiment of a system for sending container information including information on a position and sealing state of a container according to the present invention comprises (1) an electronic seal device which is provided in the container and includes a radio frequency communication module; (2) a container information transceiver which is mounted to the container and includes a condition information acquisition module for acquiring condition information of the container and a radio frequency communication module capable of performing a radio frequency communicating with the electronic seal device; (3) a relay which is disposed in a container yard where containers are collected or on a transportation means that carries the containers, and which comprises a radio frequency communication module capable of communicating with the container information transceiver, and a satellite communication module capable of performing a satellite communication; and (4) a positional information acquisition means which is mounted to at least one of the container information transceivers and the relay to be able to acquire positional information of the container.

This embodiment of the system for sending the container information is different from the aforementioned first and second embodiments thereof that the container information transceiver receives information on the sealing state of the container from the electronic seal device and then transmits the container information, including the information on the received sealing state and the container condition, to the relay. It will be understood that the techniques applied to corresponding elements are nearly the same as in the above embodiments.

With such a constitution, the electronic seal device is configured to perform a radio frequency communication with container information transceiver positioned closer than the relay. Therefore, a wireless communication distance can be reduced, and the power consumption of the electronic seal device can be also reduced. Therefore, the configuration of the electronic seal device can be further simplified.

According to the second and third embodiments of the system for sending the container information, it is preferably configured in such a manner that the container information transceiver further comprises the satellite communication module capable of performing the satellite communication with a satellite. More preferably, the container information transceiver is configured to send the positional and condition information of the container to the satellite if the container information transceiver fails to communicate with the relay.

That is, when the relay is damaged or the container information should be sent from some inland places where the relay is not installed, the satellite communication can be conducted by the container information transceiver such that reliability of the system for sending the container information according to the present invention can be enhanced.

According to the first and second embodiments of the system for sending the container information, it is preferably configured in such a manner that the electronic seal device transmits the container information to other electronic seal device disposed within a communication radius of the radio frequency communication module of the electronic seal device when it fails to communicate with the relay. Therefore, when an electronic seal device fails to communicate with the relay due to obstacles or radio interference or since the electronic seal device is placed beyond the range of the communication radius with the relay, the electronic seal device is configured to transmit the information on the sealing state of the container to other adjacent electronic seal device which in turn transmits the received information on the sealing state to the relay. Accordingly, even though an electronic seal device fails to communicate with the relay due to radio interference, the system for sending the container information can send the information on the sealing state of the container in real time.

According to the third embodiment of the system for sending the container information, it is preferably configured in such a manner that the container information transceiver transmits the container information to other container information transceiver disposed within a communication radius of the radio frequency communication module of the container information transceiver when it fails to communicate with the relay. This embodiment is nearly the same as the previous first and second embodiments in which the information on the sealing state can be transmitted by the communication between the electronic seal devices even when the communication with the relay is not conducted with ease, except that a communication device becomes a container information transceiver.

Furthermore, information for distinguishing the respective containers from one another should be provided together with the information on the position and sealing state of the container so that a third party can collect and classify the container information and then confirm the position and sealing state of the container, if necessary. A method of providing the information for distinguishing the respective containers from one another will be explained below. In general, a unique identification number is provided to each of the containers for the management thereof, while an additional unique identification number is also provided in the electronic seal device. The reason is to strengthen the security for the electronic seal device by completely removing any possibility that the unique identification number of the electronic seal device can be tampered with. For the management of the containers, it is necessary to locate the container among a plurality of containers where the information on the sealing state of the container is transmitted from the electronic seal device. Thus, the unique identification number of the electronic seal device and the unique identification number of the container should be matched one-to-one and then be arranged as a database. It is preferred that such a database is recorded in a control center to be explained later. The unique identification numbers of the electronic seal device and container are matched one-to-one and then are transmitted to the control center through a communication means of a seal scanner to be explained later. Alternatively, the matched identification numbers are stored in a storing means of a storage unit in the seal scanner and then are transmitted to the control center via a communication network such as the Internet.

Further, the unique identification numbers of the containers are stored in the container information transceiver when it is mounted to the container information transceiver. The identification numbers of the container are transmitted together when the container information is sent from the container information transceiver to the relay or satellite.

Furthermore, the relay of the present invention is arranged in at least one of the vehicle, train, ship, airplane and container dock. The container dock includes a temporary container yard where the containers are temporarily collected before the freight is loaded into the container, a container yard where the container with the freight loaded therein is sealed in the customs, a container yard and terminal where the containers are loaded onto the transportation means, and the like.

A container tracking system for tracking container information including information on a position and sealing state of a container according to the present invention comprises (1) an electronic seal device which is provided to the container and include a radio frequency communication module; (2) a relay which is disposed in a container yard where containers are collected or on a transportation means that carries the containers, and includes a radio frequency communication module capable of communicating with the electronic seal device, a satellite communication module for performing a satellite communication, and a positional information acquisition means capable of acquiring positional information of the container; and (3) a control center including a base station communication unit for receiving the container information transmitted through a satellite from a base station capable of performing a satellite communication with the satellite, an information processing unit for processing the received container information, a client communication unit for communicating with a client terminal, and an information transmitting/receiving unit for sending the container information to the client terminal with the request from the client terminal for confirming the container information, wherein the electronic seal device transmits the information on the sealing state of the container to the relay, the relay sends the container information, including the information on the position and sealing state of the container, via the satellite communication module to the satellite and then to the base station, and the control center sends the container information to the client terminal with the request of the client terminal.

That is, the present invention is configured in such a manner that the satellite, which received the container information from the system for sending the container information, transmits the information to the base station. Further, it can be understood that the container information sending system is nearly the same as the container information sending system including the aforementioned container information transceiver in view of their constitutions.

The container information flow of the container tracking system according to the present invention will be hereinafter discussed. The electronic seal device transmits the sealing state of the container to the relay, and the relay sends the container information, including the information on the position and sealing state of the container, by the satellite communication module to the satellite and then to the base station. Further, the control center sends the container information to the client terminal with the request of the client terminal. Therefore, a client who wishes to confirm the container information, such as a consignor, a ship owner and a government can access the container information, including the information on the position and sealing state of the container, regardless of the current position of the container even while the container is being transported.

Preferably, the container tracking system according to the present invention further comprises a seal scanner which includes a radio frequency module for communicating with the electronic seal device and stores management information including an identification number (ID) of the container and an identification number (ID) of the electronic seal device.

As described above, the seal scanner is provided to organize the management information including a database in which the identification numbers of the container and electronic seal device are matched one-to-one. Further, in the event that an additional communication module is provided in the seal scanner, the management information including the one-to-one matched database may be transmitted to the control center or a third database through the additional communication module. Otherwise, the management information stored in the seal scanner may be transmitted via the Internet and the like.

In addition, since the sealing state of the electronic seal device can be confirmed via the radio frequency communication module of the seal scanner without need to confirm the sealing state of the electronic seal device through the control center, a person who carries the seal scanner can easily confirm the sealing state of the electronic seal device at a spot where the container is located.

### BRIEF DESCRIPTION OF DRAWINGS

FIG. 1 is a diagram showing the configuration of a system for sending container information and a system for tracking a container including the same according to the present invention.

FIG. 2 is a diagram showing the configuration of an electronic seal device according to the present invention.

FIG. 3 is a diagram showing the configuration of a container information transceiver according to the present invention.

FIG. 4 is a diagram showing the configuration of a relay according to the present invention.

FIG. 5 is a diagram showing the configuration of a seal scanner according to the present invention.

FIG. 6 is a flowchart illustrating a process of monitoring the container tracking system according to the present invention.

FIG. 7 is a diagram illustrating communications between the container information transceivers according to the present invention.

FIG. 8 is an exploded view of an electronic seal device according to an embodiment of the present invention.

FIG. 9 is a perspective view of the electronic seal device according to the embodiment of the present invention.

### EXPLANATION OF REFERENCE NUMERALS FOR DESIGNATING MAIN COMPONENTS IN THE DRAWINGS

1: System for sending container information
2: Transportation means
3: System for tracking container
5: Container
10: Electronic seal device
20: Container information transceiver
30: Relay
40: Base station
50: Control center
60: GPS satellite
70: Communication satellite
90: Seal scanner

### PREFERRED EMBODIMENTS

Hereinafter, preferred embodiments of a system for sending container information and a system for tracking a container including the same according to the present invention will be described in detail with reference to accompanying drawings.

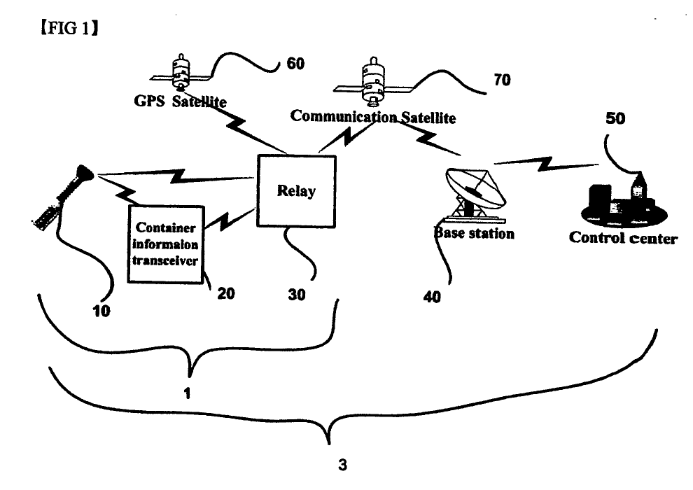

FIG. 1 is a diagram-showing the configuration of a system for sending container information and a system for tracking a container including the same according to the present invention.

As shown in FIG. 1, a system 1 for sending container information according to the present invention comprises an electronic seal device 10 provided at an opening/closing means of a container (not shown), a container information transceiver 20 mounted to the container, and a relay 30 for communicating wirelessly with the electronic seal device 10 or container information transceiver 20 to send information on the condition and sealing state of the container to a communication satellite 70 by satellite communication. As described in the section of Disclosure of Invention, it will be understood that depending on the embodiments, the system 1 for sending the container information is configured in such a manner that the container information transceiver 20 is not mounted to the container. It will also understood that the container information transceiver 20 is preferably mounted to a container, particularly when the container is an expensive container, such as a refrigerator container, in which a means for maintaining the internal environment is provided to cause the internal state to be kept at a certain condition, or a special container used to carry dangerous freight such as radioactive or chemical materials.

As shown in FIG. 1, in order to track the position of the container, it is preferred that the relay 30 receive GPS information from a GPS satellite 60 providing position tracking information and send the information on the position and sealing state of the container to the communication satellite 70. Since a distance between the relay 30 and the container is within a communication range of the RF communication module, there is no substantial error even though the position of the container is replaced with that of the relay 30 when tracking the position of the container. In particular, this configuration allows system set-up costs to be lowered, since an additional GPS terminal does not have to be installed in the container information transceiver 10 or to the information transceiver 20 mounted to each of the containers when setting up the system for sending the container information in a train, airplane, ship or container yard where a plurality of containers are collected. However, it will be understood that the GPS terminal capable of receiving the GPS information from the GPS satellite can be provided in the container information transceiver 20, depending on the embodiments, if the positional information of the container must be accurately checked. Further, it is preferred that the container information transceiver receives the information about the temperature and humidity in the container and the information about whether radioactive and biochemical materials have been leaked out or not, from a sensor for monitoring the internal environment in the container, and transmit the received information to the relay 30 together with the information on the position and sealing state of the container, as will be described later.

As described in the section of Disclosure of Invention, the system 1 for sending the container information may be configured in other embodiments such that the electronic seal device 10 can communicate with the relay 30 and transmit the information on the sealing state to the relay 30 via the container information transceiver 20.

Furthermore, a system for tracking a container according to the present invention comprises the system 1 for sending the container information, and a control center 50 which is connected to communicate with a base station 40 and a client terminal (not shown) such that the container information received from the container information sending system and transmitted to the base station 40 through the communication satellite can be transmitted again from the base station 40 to the client terminal. The communication satellite 70 sends the container information, including the information on the position and sealing state of the container, from the relay 30 to the satellite communication base station 40, and the base station 40 then transmits the container information to the control center 50 which is connected to communicate with the base station. Therefore, since the information on the position, condition and sealing state of the container can be transmitted from the container information sending system 1 to the client terminal, the container information can be acquired in real time, at the client terminal.

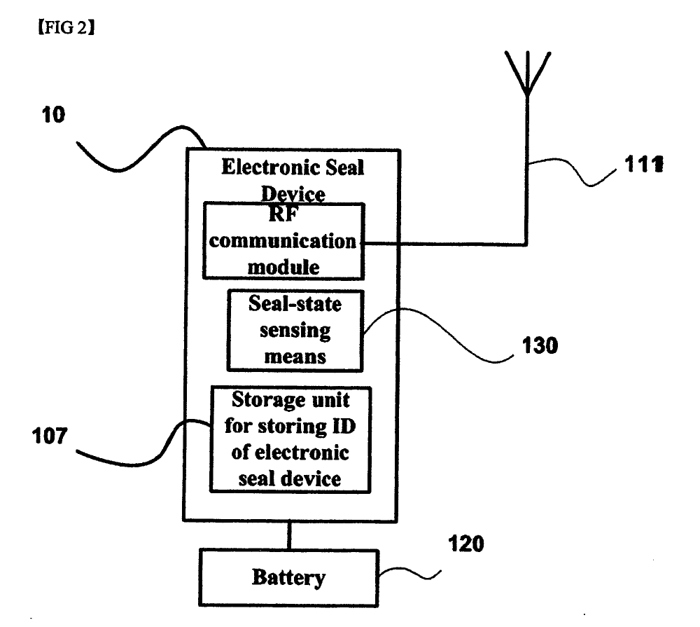

FIG. 2 is a diagram showing the configuration of an electronic seal device according to the present invention. The mechanical structure of the electronic seal device 10 or a circuit or sensing means 130 for monitoring a sealing state of the electronic seal device 10 can be configured with reference to an electronic seal device as disclosed by Korean Patent Laid-Open Publication No. 1999-0087739 and U.S. Pat. No. 6,069,563. As shown in FIG. 2, however, the electronic seal device 10 of the present invention comprises a RF communication module 101 for transmitting sealing state monitoring information determined from the sealed-state sensing means 130 to the relay or other adjacent electronic seal devices 10. In an active manner, the sealing state sensing means 130 senses whether the sealing state of the container is released, and then transmits a signal notifying the release of the sealing state to the relay or seal scanner through the RF communication module 101 when the sealing state is released. Alternatively, in a passive manner, the sealing state sensing means 130 receives a request for detecting the sealing state information from the relay or seal scanner, confirms the sealing state and transmits the confirmed information to the relay or seal scanner. The electronic seal device 10 is preferably made to be used once only, which is useful in preventing a third party from sealing again the container to conceal the fact that the third party breaks the seal to rob, damage or change the contents in the container. Further, the electronic seal device 10 preferably comprises a storage unit 107 for storing an identification number of the electronic seal device 10. The storage unit 107 for storing the identification number of the electronic seal device is preferably configured in such a manner that a serial number, which is differently inputted into each of the electronic seal devices in the process of manufacturing the electronic seal device, is stored and used as the identification number of the electronic seal device. Furthermore, the input identification number of the electronic seal device is preferably stored in a ROM (Read Only Memory) so that it is impossible to change or eliminate the identification number of the electronic seal device. In addition, a control unit for controlling the operation of the electronic seal device is preferably provided as a general-purpose microprocessor, and the identification number of the electronic seal device can be recorded into a memory of the general-purpose microprocessor. The identification number of the electronic seal device can be read out by the seal scanner to be explained later, which in turn causes the identification number of the electronic seal device and the identification number of the container where the electronic seal device is provided, to be matched one-to-one with each other and store therein.

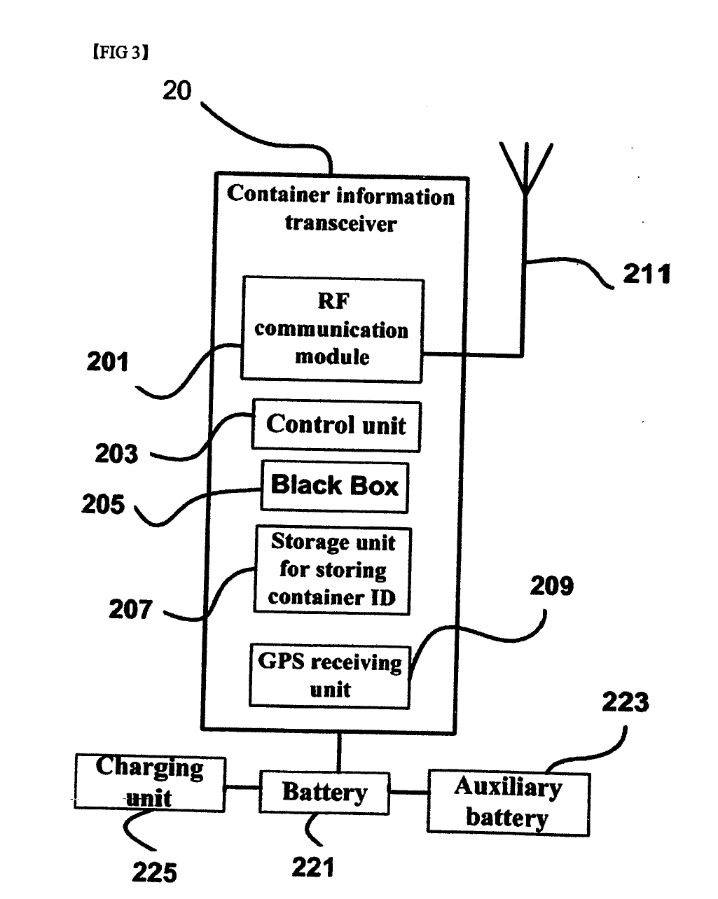

FIG. 3 is a diagram showing the configuration of the container information transceiver according to the present invention.

The container information transceiver 20 of the present invention is mounted to a container. Preferably, the container information transceiver is mounted to an inner side of the container such that it cannot be damaged while the container is carried, loaded or unloaded. More preferably, a RF communication antenna 211 of a RF communication module 201 and a satellite communication antenna 211 of a satellite communication module 250 are extended to the outside for easier communication. In the meantime, the container information transceiver 20 is configured to perform the RF communication with the relay in some embodiments, while the container information transceiver conducts the RF communication even with the electronic seal device in other embodiments. In the latter embodiments, if the RF communication frequency of the electronic seal device is different from the RF communication frequency of the relay, the RF communication module 201 of the container information transceiver 20 is preferably manufactured to be able to communicate with a plurality of frequencies. The container information transceiver 20 may comprise a GPS receiving terminal or unit 209 for receiving GPS information from a GPS satellite so as to acquire the positional information of the container. As described in the above, in the event that the relay includes the GPS receiving unit 209, it will be understood that an additional GPS receiving unit 209 is not necessarily included in the container information transceiver 20. Preferably, the container information transceiver 20 includes a Black Box 205 for recording a transport history of the container. More preferably, the positional information of the container every time, information on the internal environment every time, and the like are stored in the Black Box 205. Time information is preferably provided from a Real time Clock and the like. The Black Box 205 is preferably comprised of a high capacity flash memory such that a large quantity of information can be stored therein. Preferably, the container information transceiver 20 includes a control unit 203 for controlling the operation of respective components such as the RF communication module 201, the GPS receiving unit 209 and the Black Box 205. More preferably, the control unit 203 is comprised of a general-purpose microprocessor. In the meantime, the identification number of the container may be stored in a memory of the general-purpose microprocessor constituting the control unit 203, and is preferably inputted and stored in the same way as the unique identification-number of the container needed for managing the container.

As shown in FIG. 3, a preferred embodiment of the container information transceiver according to the present invention may further comprise a satellite communication unit 250 which serves to improve reliability of the system for sending the container information according to the present invention by causing the container information to be transmitted to a satellite even when the communication between the container information transceiver 21 and the relay cannot be smoothly conducted or when the container is positioned at a place or transportation means where the relay is not provided. Further, the container information transceiver can receive the information on the internal environment in the container from a sensor 7 for sensing the internal environment in the container and transmit the received information to the relay. Preferably, an example of the sensor 7 for sensing the internal environment in the container includes an electronic thermometer, an electronic hygrometer, a radioactive material detector, a biochemical material detector and the like such that the temperature and humidity in the container or the like can be sensed. Furthermore, in the event that the sensor 7 for sensing the internal environment in the container and a module 270 for sensing a condition of the container are separately configured, the sensing module 270 includes an interface unit for receiving a sensing signal from the sensor 7. Alternatively, the container condition sensing module 270 may include the internal environment sensing sensor 7. With such a constitution, particularly when the container is a refrigerator container or a special container designed to allow the freight in the container to be kept at a proper temperature and humidity, the carrier, consignor or ship owner can check in real time whether the internal condition in the container is kept at a desired condition. Moreover, in the event that the radioactive or biochemical materials are loaded in the container, they can also check in real time whether these dangerous materials have been leaked out.

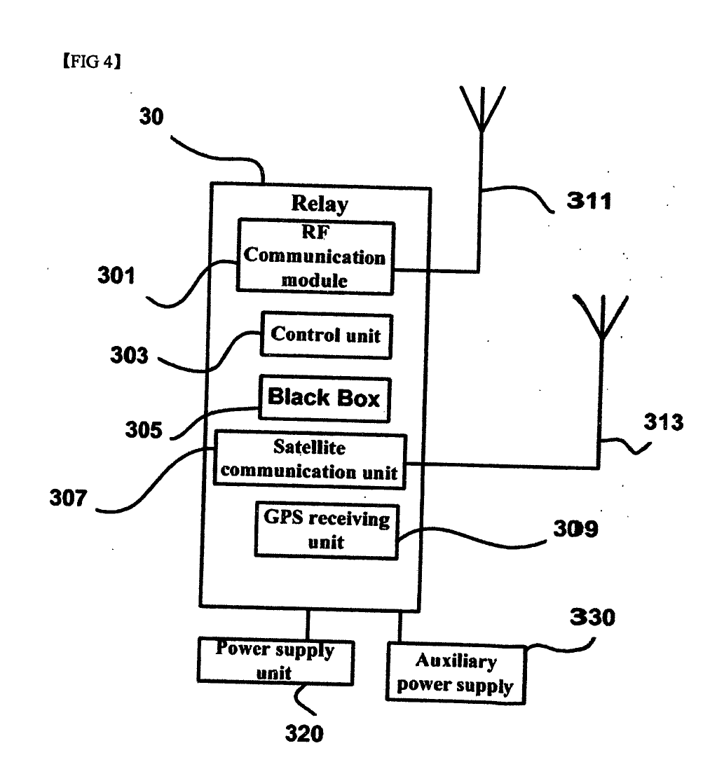

FIG. 4 is a diagram showing the configuration of the relay according to the present invention.

The relay of the present invention is provided in order to send the container information acquired by the electronic seal device or container information transceiver to the control center via the satellite, and is preferably disposed at the container transportation means, container dock or yard, airplane, ship or the like within the communication range of the radio frequency communication module of the container information transceiver to perform the communication with the transceiver. In the event that a plurality of containers are arranged in wide regions including the container dock or yard or the ship if necessary, a plurality of relays may be properly installed in consideration of the communication range of the radio frequency communication module of the container information transceiver.

As shown in FIG. 4, the relay 30 comprises a RF communication module 301 for performing the radio frequency communication with the electronic seal device or container information transceiver, a control unit 303 for controlling the operation of the respective components of the relay 30, a Black Box 305, a satellite communication module 307 and a GPS receiving unit 309. The respective components of the relay have the substantially same as those of the corresponding components illustrated in FIG. 3, except that information can be collected and sent from the plurality of electronic seal devices or container information transceivers. Therefore, it will be understood that processing capacity of the respective components of the relay is preferably greater than that of the respective components of the container information transceiver.

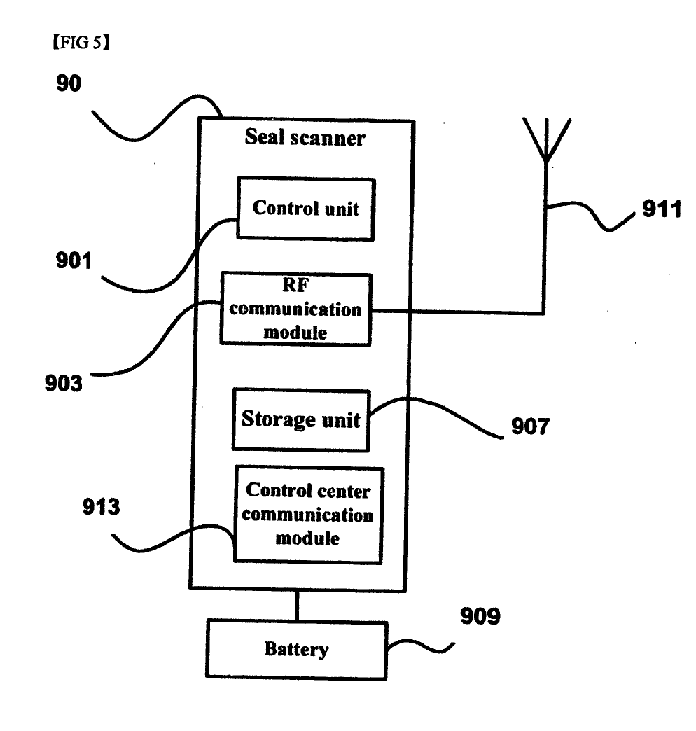

FIG. 5 is a diagram showing the configuration of the seal scanner according to the present invention.

The seal scanner 90 is provided not to receive the sealing state of the electronic seal device via the satellite but to be able to confirm the sealing state directly at a place where the container is placed, and is preferably manufactured in the form of an industrial PDA (Personal Digital Assistant). Further, the seal scanner comprises a RF communication module 903 capable of communicating with the RF communication module of the electronic seal device at the same communication frequency such that it can communicate with the electronic seal device to confirm the sealing state of the container. Preferably, the seal scanner-comprises a communication module 913 for communicating with the control center. The communication module 913 for communicating with the control center by comprised of a broadband radio frequency communication module such as CDMA, wireless LAN and satellite communication module. Further, in the event that the communication module for communicating with the control center is not provided in the seal scanner 90, the seal scanner 90 is connected to a wired communication cable such that the contents stored in a storage unit 907 can be transmitted to a database of the control center for checking and recording the sealing state through the communication network such as the Internet or telephone line.

The seal scanner 90 matches the unique identification number of the container provided on the sidewall of the container as identifiable characters one-to-one with the unique identification number of the electronic seal device read out from the electronic seal device through the RF communication module and allows the matched data to be stored. Preferably, the unique identification number of the container is input into the seal scanner through the input means such as a keypad. Preferably, the information on the sealing state received from the electronic seal device, a time when the sealing state has been confirmed, the identification number of the container, and the one-to-one matched data between the identification number of the electronic seal device and the identification number of the container with the electronic seal device mounted thereon are recorded in the storage unit 907 of the seal scanner 90. Moreover, the RF communication module 903 can be configured to communicate with the container information transceiver such that the seal scanner can also receive the information on the position of and internal environment in the container from the container information transceiver.

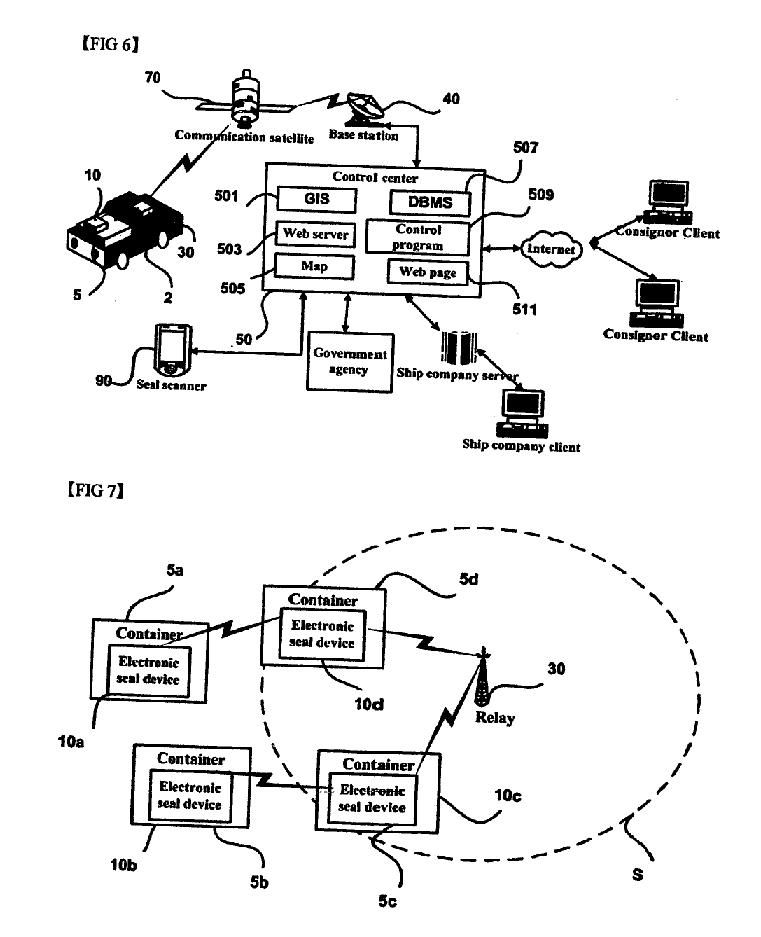

FIG. 6 is a flowchart illustrating a process of monitoring the container tracking system according to the present invention.

As shown in FIG. 6, the container tracking system of the present invention is configured in such a manner that if the relay 30 mounted to the transportation means 2 or the like transmits the container information including the information on the sealing state of the container from the electronic seal device 10 or container information transceiver (not shown) mounted in the container 5 to the communication satellite 70 through the satellite communication module of the relay 30, the satellite 70 transmits the container information to the satellite communication base station 40, and then, the control center 50 that received the container information from the satellite communication base station transmits the container information to the client terminal to which government agency, a shipping company, a consignor or the like can download the container information. As shown in FIG. 6, the control center preferably comprises GIS 501 for receiving and processing GPS data, a web server 503 for providing a web with the processed information, a digital map 505 recorded in the form of a computer readable medium, a database DBMS 507 for storing and managing the data, a C/S-typed control program 509, a web page 511, and the like. As described above, it is preferred that the seal scanner 90 transmit the management information, including the information in which the unique identification number of the electronic seal device 10 and the unique identification number of the container 5 are matched one-to-one with each other, to the DBMS 507 via a wired/wireless communication network.

FIG. 7 is a diagram illustrating the communications between the electronic seal devices according to the present invention.

The electronic seal device 10a, 10b, 10c or 10d of the present invention is preferably configured to be able to communicate with the relay 30 through the other electronic seal device when it cannot communicate directly with the relay 30. Such a configuration is used to transmit the container information to the relay 30, particularly when the electronic seal device cannot communicate with the relay because communication disorders such as the short communication range of the radio frequency communication module of the electronic seal device and communication frequency interference occurs in the container yard, ship or train where a plurality of containers 5a, 5b, 5c and 5d are collected. Preferably, the electronic seal device 10a, 10b, 10c or 10d is provided with a control unit for performing the radio frequency communication. In such a case, the container information is preferably transmitted using a signal from the relay 30 as an interrupt signal. With such a configuration, when the interrupt signal is not input for a predetermined period of time, it is preferably configured such that the container information is transmitted to the other electronic seal device and finally to the relay 30 by means of the occurrence of events.

Since the electronic seal device 10a of the container 5a that is difficult to communicate with the relay 30 is located, for example, out of the communication range S of the relay 30, the interrupt signal resulting from the communication with the relay 30 does not occur during the predetermined period of time. Thus, the control unit of the electronic seal device detects the absence of the interrupt signal and then transmits the container information on the container 5a to the electronic seal device 10d of another container 5d, which in turn transmits the container information, including the container information on the container 5d with the electronic seal device 10d itself mounted thereto and the container information on the container 5a transmitted by the other electronic seal device 10a, to the relay 30.

It will be understood that the data transmission system among the electronic seal devices 10a, 10b, 10c and 10d can be applied to the data transmission system between the container information transceivers without any modifications.

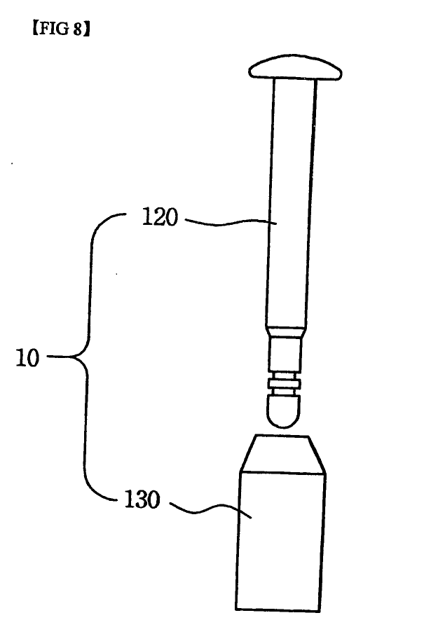

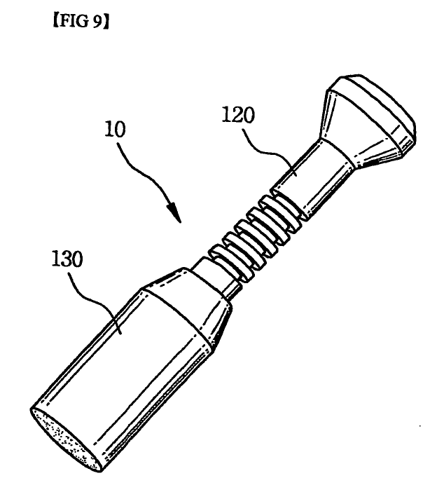

FIG. 8 is an exploded view illustrating the mechanical configuration of the electronic seal device according to a preferred embodiment of the present invention, and FIG. 9 is a perspective view of the electronic seal device according to the preferred embodiment of the present invention. As shown in FIGS. 8 and 9, the mechanical configuration of the conventional electronic seal device may be directly applied to the electronic seal device 10 of the present invention. The electronic seal device 10 of the present invention comprises a housing 130 having a hole and a key 120 insertable into the hole of the housing 130. Further, a groove is formed on the hole of the housing 130 and a protrusion corresponding to the groove is also formed on the key, such that once the key 120 is inserted into the housing 130, the key 120 cannot be unfastened from the housing 130 unless the key 120 has been cut. Furthermore, it is preferably configured in such a manner that the electronic seal device of the present invention can detect that electric current flowing along the key 120 has been cut off due to the breakage of the key 120 and thus can determine that the sealing state of the container has been released. It is possible to implement such a mechanical configuration or means for determining the sealing state with reference to the electronic seal device disclosed by Korean Patent Laid-Open Publication No. 1999-0087739 and U.S. Pat. No. 6,069,563.

Although the present invention has been described in connection with the preferred embodiments illustrated in the accompanying drawings, it is apparent that the scope of the present invention is defined by the appended claims and it should not be construed as being limited to the accompanying drawings or the aforementioned preferred embodiments.

It is also apparent that various modifications, changes and adaptations obvious to those skilled in the art and set forth in the claims fall within the scope of the present invention.

### INDUSTRIAL APPLICABILITY

The present invention can be used to establish a container information sending system for providing a service for sending container information to a third party and a container tracking system for providing a third party with a service for tracking the container information.

1. A system for sending container information including information on a position and sealing state of a container, comprising:
an electronic seal device provided in the container and including a radio frequency communication module, and
a relay disposed in a container yard where containers are collected or on a transportation means that carries the containers, said relay including a radio frequency communication module capable of communicating with the electronic seal device, a positional information acquisition means capable of acquiring the positional information of the container, and a satellite communication module capable of performing a satellite communication.

2. A system for sending container information including information on a position and sealing state of a container, comprising:
an electronic seal device provided to the container and including a radio frequency communication module;
a container information transceiver mounted to the container and including a radio frequency communication module and a condition information acquisition module for acquiring condition information of the container;
a relay disposed in a container yard where containers are collected or on a transportation means that carries the containers, said relay including a radio frequency communication module capable of communicating with the electronic seal device and the container state information transceiver and a satellite communication module capable of performing a satellite communication; and
a positional information acquisition means capable of acquiring the positional information of the container.

3. A system for sending container information including information on a position and sealing state of a container, comprising:
an electronic seal device provided to the container and including a radio frequency communication module;
a container information transceiver mounted to the container, said container information transceiver including a condition information acquisition module for acquiring condition information of the container and a radio frequency communication module capable of performing a radio frequency communicating with the electronic seal device;
a relay disposed in a container yard where containers are collected or on a transportation means that carries the containers, said relay including a radio frequency communication module capable of communicating with the container state information transceiver and a satellite communication module capable of performing a satellite communication; and
a positional information acquisition means mounted to at least one of the container information transceiver and the relay to be able to acquire the positional information of the container.

4. The system as claimed in claim 2 or 3, wherein the container information transceiver further comprises the satellite communication module capable of performing the satellite communication.

5. The system as claimed in claim 4, wherein the container information transceiver sends the positional and condition information of the container to the satellite when the container information transceiver fails to communicate with the relay.

6. The system as claimed in claim 1 or 2, wherein the electronic seal device transmits the container information to another electronic seal device located within a communication radius of the radio frequency communication module of the electronic seal device when the electronic seal device fails to communicate with the relay.

7. The system as claimed in claim 3, wherein the container information transceiver transmits the container information to another container information transceiver located within a communication radius of the radio frequency communication module of the container information transceiver when the container information transceiver fails to communicate with the relay.

8. The system as claimed in any one of claims 1 to 3, wherein the relay is arranged in at least one of a vehicle, a train, an airplane and a container yard.

9. A container tracking system for tracking container information including information on a position and sealing state of a container, comprising:
an electronic seal device provided to the container and including a radio frequency communication module;
a relay disposed in a container yard where containers are collected or on a transportation means that carries the containers, said relay including a radio frequency communication module capable of communicating with the electronic seal device, a satellite communication module for performing a satellite communication and a positional information acquisition means capable of acquiring the positional information of the container, and
a control center including a base station communication unit for receiving the container information transmitted through a satellite from a base station capable of performing a satellite communication with the satellite, an information processing unit for processing the received container information, a client communication unit for communicating with a client terminal, and an information transmitting/receiving unit for sending the container information to the client terminal with the request from the client terminal for confirming the container information,
wherein the electronic seal device transmits the information on the sealing state of the container to the relay, the relay sends the container information, including the information on the position and sealing state of the container, via the satellite communication module to the satellite and then to the base station, and the control center sends the container information to the client terminal with the request of the client terminal.

10. The system as claimed in claim 9, further comprising a seal scanner which includes a radio frequency communication module communicating with the electronic seal device and stores management information including an identification number (ID) of the container and an identification number (ID) of the electronic seal device.
